(19) United States
(12) Patent Application Publication
(10) Pub. No.: US 2024/0265091 A1
(43) Pub. Date: Aug. 8, 2024

(54) APPARATUS AND METHOD FOR VERIFYING ONE-TIME PASSWORDS

(71) Applicant: ZEHRA YILDIRIM, ANKARA (TR)

(72) Inventor: ZEHRA YILDIRIM, ANKARA (TR)

(21) Appl. No.: 18/105,379

(22) Filed: Feb. 3, 2023

(51) Int. Cl. G06F 21/45

(52) U.S. Cl. CPC G06F 21/45

(57) ABSTRACT

A verification apparatus for verifying one-time passwords includes a data processing device and a data acquisition device operatively coupled to the data processing device. The data processing device is configured to obtain verification data for verifying a one-time password using the data acquisition device.

### TECHNICAL FIELD OF THE INVENTION

The field of the present invention generally relates to devices, methods and systems for validating one-time passwords and to metering devices and actuator arrangements implementing validation of one-time passwords.

### BACKGROUND OF THE INVENTION

In the field of information and telecommunications technology, authentication is a data acquisition process in which authorization to access a system or data is proven by performing a validity check, i.e. verification of a password. For example, a kiosk such as an electric charging station needs to establish a communication link with an authentication server via a communication network in order to authenticate a user. In closed areas such as underground parking garages and rural areas, authentication servers may not be accessible due to lack of cellular coverage.

A tan (transaction number) method can be used to authenticate a user, using one-time passwords in the form of tans dynamically generated in response to a request or predetermined static tans. It is known that one-time passwords do not protect against man-in-the-middle attacks and attacks on encryption methods. Defending against these attacks is difficult without a hardware source of entropy.

A solution that eliminates the disadvantages of the known devices is therefore needed to enable offline authentication of users from a plurality of users of self-service devices or machines, with the security of the authentication being guaranteed and no Internet connection being required at the place of use.

### BRIEF DESCRIPTION OF THE PRESENT INVENTION

The present invention provides apparatus, methods and systems as set out in the appended claims and as described below.

The present invention provides a verification apparatus for verifying one-time passwords, the verification apparatus comprising a data processing device and a data acquisition device operatively coupled to the data processing device. The data processing device is configured to:
obtain first verification data to verify a first one-time password;
obtain the first one-time password using the data acquisition device;
start a first data acquisition process once it obtains the first one-time password;
obtain subsequent verification data for verification of a subsequent one-time password using the data acquisition device;
perform verification of the first one-time password based at least on the first verification data;
complete the first data acquisition process before the data processing device obtains the subsequent one-time password, wherein the data processing device is further configured to obtain the subsequent verification data during the first data acquisition process or between receiving the first one-time password and completing the first data acquisition process.

The data processing device is configured to obtain the subsequent one-time password using the data acquisition device and to start a subsequent data acquisition process once it obtains the subsequent one-time password.

The data processing device may be configured to perform verification of the first one-time password before or after receiving the subsequent verification data. The first data acquisition process may include a first transaction by a user. The data processing device may be configured to perform a first transaction during the first data acquisition process, or after verification of the first one-time password, to start and end the first transaction to complete the first data acquisition process.

Having the data processing device obtain the subsequent verification data once the data processing device receives the first one-time password ensures that the subsequent verification data for verification of a subsequent one-time password is available in advance, thereby contributing to the security of the verification, since the subsequent verification data is available and accessible for a relatively short time and is not transmitted during the verification of the subsequent one-time password.

The subsequent verification data may include next, next but one or second next or third next etc. verification data for verifying a next, next but one or second next or third next etc. one-time password, wherein the subsequent one-time password may include a next one-time password obtained immediately after completion of the first data acquisition process. The first verification data may include preliminary or current verification data.

In accordance with the present invention, the verification apparatus may include an output device operatively coupled to the data processing device, and the data processing device may be further configured to perform at least one or more of the followings:
outputting a first output based at least on the first verification data using the output device;
requesting the first one-time password via the output device preferably by outputting the first output;
obtaining the subsequent verification data for verifying the subsequent one-time password using the data acquisition device once the data processing device receives the first one-time password in response to the request via the data acquisition device;
outputting a subsequent output based at least on the subsequent verification data using the output device;
requesting the subsequent one-time password via the subsequent output device preferably by outputting the output.

In accordance with the present invention, the data processing device may be configured to obtain the first verification data for verifying a first one-time password using the data acquisition device.

In accordance with the present invention, the data processing device is configured to initiate collection of the subsequent verification data when it receives the first one-time password. In doing so, the data processing device obtains the first one-time password that is entered by a user in response to requesting the first one-time password. In accordance with the present invention, the data processing device is configured to initiate collection of the subsequent verification data in response to receiving or entering the first one-time password, or to collect subsequent verification data in response to receiving or entering the first one-time password, respectively.

In accordance with the present invention, the data processing device may be configured to obtain the first verification data prior to requesting the first one-time password, or to obtain the subsequent verification data prior to requesting the subsequent one-time password, and preferably after requesting the first one-time password. The data processing device may be configured to complete the first data acquisition process prior to requesting the subsequent one-time password.

According to the present invention, the data processing device may be configured to generate the subsequent verification data once the data processing device receives the first one-time password or after performing verification of the first one-time password and regardless of the result of the verification or regardless of whether the first one-time password is verified or not, once the data processing device received the first one-time password in response to the request via the data acquisition device. The data processing device may be configured to start collecting the subsequent verification data immediately after the verification is performed, preferably continuously, or to receive the subsequent verification data preferably continuously or immediately after the verification is performed.

The data acquisition device preferably comprises:
an input device, preferably with a keypad, such that the data processing device can at least preferably receive one-time passwords containing or embedded verification data using the input device, wherein the data processing device can be configured to extract the first or subsequent verification data from the one-time passwords, e.g. by analyzing or extract parsing of one-time passwords, and/or
a measuring device, preferably with a transmitter, sensor or transducer, wherein the data processing device can be configured to obtain the first or subsequent verification data using the measuring device, preferably in which the data processing device performs a measurement using the transmitter, sensor or transducer to capture first or subsequent verification data, where verification data includes measurement data. As a result, the data acquisition device provides a hardware source of entropy.

In accordance with the present invention, once the data processing device has received the first one-time password, the data processing device may be configured to extract the subsequent verification data from the first one-time password.

In accordance with the present invention, once the data processing device has received the first one-time password and performed the verification of the first one-time password, the data processing device may be configured to control the measuring device to collect the subsequent verification data. The data processing device can be configured to control the measuring device, preferably continuously, immediately after the verification has been carried out, in order to obtain the subsequent verification data.

The data processing device may further be configured to collect first measurement data based at least on the measurement, generate an output based at least on the collected first measurement data such that the collected first measurement data can be output via the output device, and verify the first one-time password based at least to be carried out on the obtained measurement data. Thereby, the first one-time password entered by a user in response to the output via the input device is obtained, such that a first transaction of the user is authenticated by the verification apparatus.

According to a further aspect, the present invention provides a verification apparatus for verifying one-time passwords, wherein the verification apparatus comprises an output device, an input device, and a data processing device operatively coupled with the output device and the input device, and configured to generate an output, to output the output via the output device, prompting for one-time password, to receive a one-time password in response to the output via the input device and to carry out a verification of the one-time password, wherein the verification apparatus further comprises a measuring device operatively coupled to the data processing device and the data processing device is further configured to control the measuring device in such a way to perform a measurement using the measuring device, to obtain measurement data based at least on the measurement, to generate the output based at least on the obtained measurement data such that the obtained measurement data is output via the output device, and to carry out the verification of the one-time password based at least on the obtained measurement data. The data processing device is further configured to obtain a result of the verification. Thereby, the one-time password inputted by a user in response to the output via the input device is received, such that a current transaction of the user is authenticated by the verification apparatus.

The data processing device obtaining the measurement data before prompting for the one-time password ensures that the measurement data to verify the one-time password is available in advance, thereby contributing to the security of the verification, since the measurement data won't be transmitted during the verification of the one-time password.

The verification apparatus according to the invention can be designed to authenticate subsequent transactions, the measurement being carried out after authentication of a previous transaction by verification of a previous one-time password, such that the measurement data relate to the previous transaction. Accordingly, the data processing device may be configured to perform a next measurement after verification of the one-time password using the measuring device, to capture next measurement data based at least on the measurement, to generate a next output based at least on the captured next measurement data, such that the captured next measurement data can be output via the output device, and to carry out verification of a next one-time password based at least on the detected next measurement data. The data processing device may be configured to preferably uninterruptedly begin collecting the next measurement data immediately after performing the one-time password verification. The data processing device may be configured to collect the next measurement value to verify a next one-time password once the data processing device receives the one-time password. According to the present invention, the data processing device can be configured to initiate the acquisition of the next measurement data or to control the measuring device to carry out or initiate a next measurement when it receives the one-time password. The data processing device receives the one-time password that is entered by a user in response to the output. In accordance with the present invention, the data processing device may be configured to initiate collection of the next measurement value in response to receiving or entering the one-time password or collecting the next measurement value in response to receiving or entering the one-time password. The data processing device may be configured to collect the measurement value prior to requesting the one-time password and to collect the next measurement value prior to requesting the next one-time password. The data processing device can be configured to collect the next measurement data after performing the verification of the one-time password and regardless of the result of the verification or whether the one-time password is verified or not. According to the present invention, once the data processing device has received the one-time password and performed the verification of the one-time password, the data processing device may be configured to control the measuring device to obtain the next measurement data. The data processing device can be configured to control the measuring device, preferably continuously, immediately after the verification of the one-time password has been carried out, in order to obtain the next measuring data.

The data processing device is configured to calculate a measurement value using the measurement data such that the output is generated based at least on the measurement value and the verification of the one-time password is performed based at least on the measurement value.

The verification apparatus preferably includes a counter, the data processing device being configured to update a counter value using the measurement value. The data processing device can include the counter.

The verification apparatus according to the invention comprises a memory. The first verification data is stored in the memory and the data processing device is configured to retrieve the first verification data from the memory after starting the verification apparatus, including restarting or powering-on the verification apparatus. The data processing device may be configured to store subsequent verification data in data storage, which may be retrieved from data storage as first verification data after a start of the verification apparatus. The data processing device can be configured to store the measurement data or the measurement value or the counter value in the memory and to retrieve the measurement data or the measurement value or the counter value from the memory after a start of the verification apparatus in order to produce a first output based on at least to generate the retrieved measurement data or retrieved measurement value or retrieved counter value, such that the retrieved measurement data or measurement value or counter value can be output via the output device, to obtain a first one-time password in response to the first output via the input device, and verification of the first one-time password based at least on the retrieved measurement data or retrieved measurement value or retrieved counter value. The data processing device may be configured to generate a verification password using at least one of the first or subsequent verification data, measurement data, measurement value or counter value.

The verification data can contain a verification password or a position number, or the data processing device can be configured to provide a verification password from a verification password list according to the position number using at least the verification data or to generate it according to a predetermined coding algorithm. Accordingly, the data processing device may be configured to replace the stored verification data with the received verification data upon receipt.

The data processing device may be configured to verify the one-time password based at least on the verification password or by comparing it to the verification password, in which the one-time password is verified once the one-time password and the verification password match, and the one-time password is not verified once the one-time password and the verification password do not match.

The data processing device can be configured to generate the output based at least on the measurement data or using the measurement value or the counter value by processing at least the measurement data or the measurement value or the counter value in order to create the output that the measurement data integrated into the output or the measurement value or the counter value are output together with the output or in the output via the output device when the output is output via the output device. The measurement data or the measurement value or the counter value are integrated into the output in a restorable manner.

The data processing device is preferably also configured to generate the output by coding or encrypting at least the measurement data or the measurement value or the counter value, such that the encrypted measurement data or measurement value or counter value can be restored or extracted from the output by decoding or decrypting.

The data processing device is configured to start the measurement to then obtain the measurement data and to stop the measurement to then generate the output based at least on the measurement data.

The data processing device is advantageously configured to measure a consumption using the measuring device, such that the measurement data or the measurement value or the counter value contain consumption data, such that the consumption data are output via the output device. The consumption data includes previously carried out measurements.

The verification apparatus according to the invention has the advantage over known verification apparatus that it has to perform a measurement by the measuring device and output measurement data generated by the measurement in a recoverable format in order to verify a one-time password such that the measurement can be registered externally. Accordingly, the verification apparatus or measuring device acts as a measuring device and at the same time also as a source of uniqueness or entropy that provides the randomness needed in verification.

The data processing device is preferably also configured to use the measuring device to store the measurement data or the measurement value for a limited span or in a preferably predetermined span or a span determined by a user, preferably in a predetermined time span or a period determined by a user. The measuring device cannot be synchronized and does not have to be synchronized. The data processing device is preferably further configured to generate the measurement data, the measurement value, until the output is generated. The measurement may be stoppable.

Carrying out a verification based at least on the measurement data preferably includes carrying out a verification using at least part of the measurement data of the measurement value. The one-time password is generated by an external generator device based on the output, with the measuring device not having to be synchronized with the generator device or a generator measuring device and the generator device not having to be synchronized with the measuring device.

The measuring device preferably comprises a transducer (electrical transducer providing a signal based on measurement), wherein the measuring device provides a signal using the transducer, and the data processing device is further configured to receive the signal from the measuring device, and the measurement data or the measurement value based at least on the signal generate. In this case, the signal sent by the measuring device is received and the measurement value is calculated using at least the signal. The transducer can detect physical or chemical properties of an environment in which the measuring device is arranged. The data processing device carries out the measurement by receiving and processing the signal from the measuring device in order to obtain or generate measurement data.

The memory preferably comprises a non-volatile memory for storing data or computer instructions or programs, with the data processing device preferably being configured to store the measurement data or the measurement value or the counter value in the non-volatile memory. In this case, the data processing device can include the memory.

The data processing device is preferably configured to calculate the measurement data or the measurement value by processing the received signal. The counter is preferably implemented by a computer program. The data processing device is preferably configured to calculate the counter value by adding the measurement value to an existing counter value. The output may be generated based at least on the counter value or existing counter value, the data processing device preferably being configured to store the counter value in the non-volatile memory and to retrieve the existing counter value from the non-volatile memory, the data processing device accessing the non-volatile memory accesses to read the existing counter value.

The verification apparatus preferably further comprises a numeric value generator, wherein the data processing device is further configured to generate an auxiliary numeric value using the numeric value generator, wherein the output can be generated further based on the auxiliary numeric value if the data acquisition device is not able to obtain subsequent verification data. The numerical value generator preferably comprises an auxiliary measuring device, an input device, a button or a keypad for receiving input from a user, an auxiliary transducer, an auxiliary sensor, an auxiliary current sensor, an auxiliary power sensor, an auxiliary flow sensor, a timer, a counter module, a random number generator, a camera and/or a microphone, each of which forms an auxiliary source of uniqueness and can be designed to generate the auxiliary numerical value. The data processing device can be configured to carry out an auxiliary measurement using the auxiliary measuring device in order to use the auxiliary measuring device to generate auxiliary measurement data or auxiliary measurement value or auxiliary counter value as an auxiliary numerical value, wherein the output is generated based on the auxiliary measurement data or the auxiliary measurement value or auxiliary counter value. The auxiliary measuring device can include a virtual measuring device or a virtual measuring device. Once the counter value has not been changed, i.e. once the measuring device does not provide a measurement value or once the counter value has already been used in generating a previous e.g. first output, the counter value is updated using the auxiliary measurement value, wherein the counter value is changed by adding the auxiliary measurement value obtained using the auxiliary measuring device.

The data processing device is preferably configured to generate the output by coding or encrypting at least the measurement data or the measurement value and/or the identifier and/or the auxiliary numerical value according to a predetermined coding algorithm. The verification apparatus can include a plurality of coding algorithms, it being possible for the predetermined coding algorithm to be selected from the plurality of coding algorithms based at least on the measurement data, the measurement value and/or the auxiliary numerical value. The encoding algorithm includes a corresponding predetermined decoding algorithm and is not hashed or is injective, such that the measurement data or the measurement value or the identifier can be restored or extracted from the output by decoding or decrypting according to the predetermined decoding algorithm.

The output device preferably includes a display on which the output is displayed. The transducer and/or the auxiliary transducer preferably includes a sensor, a current sensor, a power sensor or a flow sensor.

The input device preferably includes a keypad. The input device or the output device can also include short-range wireless data transmission means in order to ensure data communication between the verification apparatus and a generator device.

Accordingly, the data processing device is operatively connected to the output device, the measuring device, the input device, and the non-volatile memory.

The data processing device is preferably also configured to generate a verification password based at least on the measurement data or the measurement value or the counter value in order to verify the one-time password using the verification password. The verification password can contain a nonce. The verification password can be generated based at least on the counter value or existing counter value.

The data processing device preferably includes an auxiliary counter that provides an auxiliary counter value based on the auxiliary measurement value. The data processing device is preferably configured to calculate the auxiliary measurement value by processing an auxiliary signal received from the auxiliary measuring device. The auxiliary counter is preferably implemented by a computer program. The data processing device is preferably configured to calculate the auxiliary count by adding the auxiliary measurement value to an existing auxiliary count. The output can also be generated based on the auxiliary counter value or existing auxiliary counter value and the check password can also be generated based on the auxiliary counter value or existing auxiliary counter value, with the data processing device preferably being configured to convert the auxiliary counter value into to store the non-volatile memory and to retrieve the existing auxiliary count value from the non-volatile memory, the data processing device accessing the non-volatile memory to read the existing auxiliary count value.

The measuring device or the transducer preferably comprises a corresponding connection in order to be arranged directly or indirectly on a transmission line and in order to obtain the properties of a transmission in the transmission line via the connection, such that the transmission in the transmission line can be detected by the data processing device. The data processing device generates measurement data based on or relating to the transmission, such that the measurement data or the measurement value can be generated when there is a transmission of the consumer goods in the transmission line, such that the measurement data or the measurement value are generated intermittently. The data processing device is preferably configured to generate the auxiliary measurement data or the auxiliary measurement value essentially continuously, regardless of whether there is a transmission in the transmission line of the consumer goods. The verification apparatus preferably includes an electrical supply line on which the auxiliary measuring device can be arranged. The data processing device may further include a time measurement unit and configured to time measure elapsed time during transmission using the time measurement unit. The data processing device can also be configured to update the counter value of the counter using the measurement data or the time measurement.

The data processing device is preferably configured to apply challenge-response (output-response) verification methods, wherein the output comprises a challenge and the one-time password comprises a response.

The data processing device is preferably configured to compare the verification password to the one-time password and determine whether the verification password and the one-time password match to perform verification of a one-time password using the verification password, wherein the verification password is generated as a verification apparatus-side one-time password. The data processing device is preferably configured to generate the verification password according to a verification algorithm. The verification apparatus can include a variety of verification algorithms, wherein the predetermined verification algorithm can be selected based on the output or measurement value, such that the predetermined verification algorithm corresponds to a predetermined one-time password algorithm that is used when generating the one-time password the generator device was used.

The present invention provides a generator device for generating one-time passwords, wherein the generator device comprises at least one generator input device, one generator output device and one generator data processing device configured to receive an output via the generator input device, to process the output, to obtain data by processing the output, generate a one-time password based at least on the data obtained by processing the output; and output the one-time password via the generator output device. In doing so, the output that is input by a user via the generator input device is received. Processing the output preferably includes decoding the output to obtain data, preferably at least measurement data.

Compared to known generator devices, the generator device according to the invention has the advantage that it must receive a measurement carried out by a measuring device in order to verify a one-time password such that the measurement can be registered. Accordingly, the generator device functions as a one-time password generator and at the same time also as a register.

The generator data processing device is configured to store the output-based data in non-volatile generator data storage.

The generator input device and the generator output device preferably each comprise a user interface for inputting the output or outputting the one-time password. The generator device according to the invention can be a computer program to be executed on a user terminal with a user interface for inputting the output, and for transmitting the output or the data based on the output to the central generator device and a computer program to be executed on the generator device for obtaining, analyzing or decrypting and storing the output or the data based on the output, wherein the data based on the output is stored in a non-volatile memory of the generator device. The generator data processing device is preferably configured to store the data based on the output in a non-volatile memory of the user terminal, preferably temporarily, preferably until a connection to the generator device is established.

The generator device according to the invention is preferably configured such that the output is decrypted by the generator device according to a predetermined decoding algorithm, to extract or recover at least one identifier and associated measurement value from the output, wherein the data based on the output includes at least the identifier and the associated measurement, the identifier and the associated measurement being stored associatively. The one-time password is preferably generated according to a predetermined one-time password algorithm as a generator-side response to the output. The one-time password can contain a nonce. One-time password algorithm is preferably non-injective and includes a hash function. The computer program to be executed on the generator device can include a plurality of decoding algorithms, wherein the predetermined decoding algorithm can be selected from the plurality of decoding algorithms based on the output, such that the predetermined decoding algorithm corresponds to the predetermined encoding algorithm. The generator computer program can include a variety of one-time password algorithms, wherein the predetermined one-time password algorithm can be selected from the plurality of one-time password algorithms based on the output or the measurement.

The present invention also provides a system for verifying one-time passwords, which comprises the verification apparatus according to the invention and the generator device according to the invention.

The present invention further provides a meter comprising the verification apparatus according to the invention.

The present invention further provides an actuator arrangement comprising the inventive verification apparatus for verifying one-time passwords to authenticate users or transactions. The verification apparatus of the actuator arrangement comprises a switch, the data processing device being able to control the switch based on the result of verification. The actuator arrangement can be arranged to control transfer of consumer goods and the switch can be arranged to control transfer of the consumer goods based on the result of the verification.

Compared to known actuator arrangements, the actuator arrangement according to the invention has the advantage that it has to carry out a measurement and output measurement data obtained through the measurement in order to be able to control the switch, such that the measurement data can be registered externally. Accordingly, the actuator arrangement functions as a measuring device and at the same time also as a control device.

The switch can be placed on a transmission line for transmission of consumer goods. The transmission line may include a load line forming part of a load circuit.

The sensor or transducer or the measuring device is preferably arranged directly or indirectly on the transmission line or the switch. The transducer or measuring device is preferably located on the switch to substantially detect the transmission flowing across the switch when the switch is on.

The data processing device is configured to control the switch by turning the switch on and off by the data processing device, to connect or disconnect the transmission line or to close or open the load circuit, wherein a control circuit is controlled by the data processing device, or a control voltage is applied by the data processing device to the switch, or a control current is provided by the data processing device to the switch.

Accordingly, the data processing device is operatively connected to the output device, measuring device, input device, memory, and switch such that the data processing device communicates with, and powers, the output device, measuring device, input device, memory, and switch, as the case may be can.

Compared to known actuator arrangements, the actuator arrangement according to the invention has the advantage that it must carry out a measurement of the transmission controlled by the actuator arrangement and output measurement data obtained through the measurement in order to be able to control the switch, such that the measurement data of the transmission controlled by the actuator arrangement are external can be registered.

The actuator arrangement according to the invention is preferably designed in such a way that the transducer is arranged to detect the transfer of the consumer goods, such that the data processing device generates the measurement data or the measurement value intermittently when the consumer goods are being transferred. The actuator arrangement according to the invention is preferably designed in such a way that the data processing device generates the measurement data or the measurement value based on the state of the switch.

The autonomous, password-protected, offline-functional actuator assembly for controlling the transmission of consumer goods of the present invention can operate independently of network connection to control the flow in a transmission line, or to collect data based on the flow in the transmission line. Accordingly, the actuator arrangement provided by the present invention for controlling the transmission of the consumer goods comprises means for controlling the transmission in the transmission line or means for collecting data based on or relating to the transmission in the transmission line. According to a further aspect, the actuator arrangement is configured to carry out the verification of one-time passwords based on or with regard to the transmission in the transmission line.

The actuator arrangement or verification apparatus according to the present invention preferably does not include any means for connecting to or configured for connecting to a data communication network or the Internet.

A verification method for verifying one-time passwords according to the present invention includes:
obtaining, by a data processing device, with a data acquisition device operatively coupled to the data processing device, first verification data for verifying a first one-time password;
obtaining, by a data processing device, subsequent verification data to verify a subsequent one-time password using the data acquisition device once the data processing device receives the first one-time password; and
performing, by a data processing device, verification of the first one-time password based at least on the first verification data;
starting a first data acquisition process by the data processing device once it obtains the first one-time password;
the data processing device terminating the first data acquisition process before the subsequent one-time password is received by the data processing device; and
obtaining the subsequent verification data by the data processing device during the first data acquisition process.

The data processing device is configured to repeat the method steps. Accordingly, the verification method according to the present invention may further include: obtaining the subsequent one-time password using the data acquisition device; and starting a subsequent data acquisition process once it obtains the subsequent one-time password.

The verification method according to the present invention may further include:
obtaining first verification data comprising retrieving a counter value from a memory;
generating a first output based at least on the counter value;
outputting the first output via the output device;
obtaining a one-time password based on the first output via an input device;
generating a verification password based at least on the counter value;
performing verification of the first one-time password, comprising performing verification of the one-time password based on the verification password;
turning on the switch;
obtaining subsequent verification data by acquiring subsequent verification data, comprising performing a measurement using a measuring device and updating the counter value using the measurement value produced by the measurement until the switch is turned off;
turning off the switch;
storing the updated counter value in data storage.

According to one aspect, the data processing device is arranged to start and/or stop a preferably electrical current flow in the transmission line, the transmission line preferably comprising an electrical line. Accordingly, the switch comprises an electrical switch or an electromechanical relay or an electronic switch which is arranged on the electrical line, to start and/or stop the current flow or to close or open the load circuit, and the transducer preferably comprises a current sensor that detects physical characteristics of the electrical current in the electrical line or in the load circuit, where the signal is based on the electric current. Alternatively, the electrical switch may comprise an electrically actuated fluid valve, with the transmission line comprising a fluid line.

The data processing device may include any suitable data processing device with analog/digital signal and power input and output ports, memory, and microprocessor(s), such as a controller, a programmable logic data processing device (PLC), microprocessor, microdata processing device, computer, or hardwired device that performs operations based on a hardwired logic of the device. These devices may be commercially available devices suitably programmed or instructed to perform operations described herein from the instructions described above. Auxiliaryly or alternatively, one or more of these devices may be hardwired to logic circuitry to perform these operations.

The verification apparatus has an identifier and the data processing device is configured to generate the output based on the measurement and the identifier, preferably according to a predetermined algorithm, preferably in which the measurement and the identifier are preferably partially encrypted according to the predetermined algorithm. The output can contain a nonce. Accordingly, a one-time beacon or nonce can be generated by encoding at least usage information and identification information, preferably according to a predetermined algorithm. One-time beacon or nonce can contain a number or a character string or a combination of these.

The data processing device is preferably adapted to select the predetermined algorithm from a plurality of algorithms, each based on at least a portion of the output or the one-time password or the measurement. The plurality of algorithms are preferably stored in the non-volatile memory of the verification apparatus.

The data processing device preferably includes a timing unit, which preferably includes a clock or a virtual timing unit in the form of a computer program executed by the data processing device configured to provide a time measurement in the form of a timing output signal or timing data based on when the switch is turned off and/or on. The timing unit may be arranged to provide a time measurement based on the time it approximately measures during transmission through the switch, or on the time when the switch is turned off and/or on, or based on the time between a start time and an end time elapsed time when the switch is turned on and off. The measurement value or the output can be generated based on the time measurement.

In addition, the output device and/or the input device may be operably coupled to the data processing device and preferably configured to be portable and/or moveable and/or slidable with respect to the data processing device.

The present invention preferably includes performing verification of a one-time password by the data processing device to enable switch off.

Performing a one-time password verification to enter a state that breaks the transmission line or prevents transmission forces the measurement of the completed transmission to be registered externally.

The verification is performed according to a challenge-response based one-time password verification protocol, preferably using an algorithm, and by verifying that the one-time password is correct by comparing the verification password or verifier-side one-time password with the one-time password.

The present invention also provides a non-transitory computer-readable medium storing a program which, when executed by a processor of the verification apparatus, configures the processor to perform the following steps of a computer-implemented verification method:
generating measurement data using the measuring device;
generating an output based at least on the measurement data by processing the measurement data;
outputting the output via the output device;
obtaining a one-time password via the input device;
applying verification to the one-time password using at least the measurement data to verify the one-time password;
obtaining a verification result;
processing predetermined instructions based on the verification result.

Applying verification to the one-time password preferably comprises generating a verification password based at least on the measurement data and comparing the one-time password to the verification password and determining whether the verification password and the one-time password match. Generating a verification password at least based on the measurement data preferably comprises generating a verification password at least based on the measurement data using a predetermined verification algorithm by encrypting at least the measurement data.

The verification method preferably further comprises before generating the measurement data: retrieving a counter value from a non-volatile memory and generating an output based at least on the counter value by processing the counter value;
outputting the output via the output device;
obtaining a one-time password via the input device;
applying verification to the one-time password using at least the counter value to verify the one-time password and obtaining a verification result;
processing predetermined instructions based on the verification result.

The verification method preferably further comprises after generating the measurement data: updating the counter value by adding a measurement value obtained using the measurement data; storing the counter value in the non-volatile data storage;
generating an output based on the counter value by processing the counter value.

The computer-implemented verification method preferably further comprises:
selecting the predetermined coding algorithm from a plurality of coding algorithms each based on at least a portion of the measurement; or.
selecting the predetermined verification algorithm from a plurality of verification algorithms based respectively on at least a portion of the output or the one-time password or the measurement; or.
generating an auxiliary numerical value; or.
generating the output by combining the measurement value and the identifier and, if necessary, the auxiliary numerical value according to a predetermined coding algorithm.

Operating predetermined instructions preferably includes controlling a component operatively coupled to the data processing device, the component preferably comprising a switch.

The present invention also provides a non-transitory computer-readable medium storing a program which, when executed by a processor of the generator device, configures the processor to perform the following steps of a computer-implemented one-time password generation method:
receiving an output via the generator input device and decoding the output to obtain at least one measurement;
storing the measurement value in the generator memory;
generating a one-time password based at least on the measurement by processing the measurement.

Generating a one-time password preferably comprises generating a one-time password using a one-time password algorithm by encrypting at least the measurement value.

The computer-implemented verification method preferably further comprises:
selecting the predetermined decoding algorithm from a plurality of decoding algorithms, each based on at least a portion of the output; and/or
selecting the predetermined one-time password algorithm from a plurality of one-time password algorithms each based on at least a portion of the output or the measurement.

The components such as the printed circuit board (PCBA) of an electrically actuated switch, measuring device, transducer are known to those skilled in the art and are not described in detail in this disclosure. In this case, a measuring device can also include auxiliary electronics such as measuring transducers, output amplifiers, A/D converters and/or bus couplings, etc. The measurement value, the auxiliary numerical value, the auxiliary measurement value, the identifier, the output, the one-time password and the check password each comprise a number or combination of numbers or have one or more numerical values.

The measuring device can have a measuring unit that is set up to convert analog signals into digital signals. Analog current and voltage signals can be converted into digital current and voltage signals accordingly. The measuring unit can also be arranged to filter and calculate electrical power and energy data. The data can be processed in one or more processing units.

Other advantages of the present invention are defined in the appended claims.

### BRIEF DESCRIPTION OF THE DRAWINGS

The above described and other issues and features of the present invention will become more apparent from the following detailed description of preferred embodiments of the invention and the accompanying drawings.

FIG. 1 is a schematic representational representation of an exemplary preferred embodiment of a system including verification apparatus for verifying one-time passwords and generator apparatus for generating one-time passwords according to the present invention;

FIG. 2 is a representative illustration of an exemplary preferred embodiment of an actuator assembly according to the invention for controlling a transmission line with a verification apparatus according to the invention;

FIG. 3 is a schematic representative representation of an exemplary preferred embodiment of a verification apparatus according to the invention;

FIG. 4 represents a flow chart of an exemplary preferred embodiment of a method according to the invention.

### DETAILED DESCRIPTION OF EXEMPLARY PREFERRED EMBODIMENTS

Preferred embodiments of the present invention are described below with reference to the accompanying drawings, in which the same reference numbers refer to the same features.

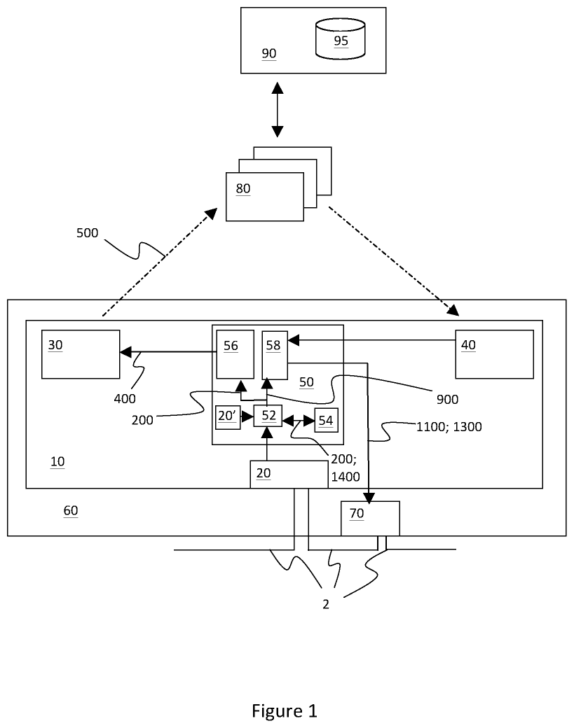

FIG. 1 shows a preferred embodiment of a system according to the invention. The system comprises a verification apparatus 10 according to the invention for verifying one-time passwords and a generator device 90 according to the invention for generating one-time passwords. The verification apparatus 10 is arranged in an actuator arrangement 60 according to the invention for controlling a transmission line 2. The transmission line 2 comprises a power line, but can also be designed for a transmission of the consumer goods, for example consumer goods flows provided in the form of consumer goods sources. In this case, the actuator arrangement 60 comprises a switch 70, which is arranged in order to close or open the transmission line 2, such that a consumer good, in the present embodiment current, is transferred via the transmission line. Alternatively, the switch 70 can be arranged in the verification apparatus 10. The verification apparatus 10 comprises a data processing device 50 and a measuring device (measuring deviceing device) 20, which is arranged on the transmission line 2 in order to detect the properties of the current such as current intensity or voltage in the transmission line 2 and transmit them to the data processing device 50 in the form of an analog signal. If necessary, the measuring device 20 can detect various physical properties of the transmission or of the consumer good in the transmission line 2 and transmit them to the data processing device 50 in the form of an analog signal, such that a measurement value can be generated. According to the present embodiment of the invention, the measuring device 20 comprises a current sensor and the data processing device 50 comprises a time measuring unit in order to carry out a time measurement with regard to elapsed time during the measurement, such that the data processing device 50 can detect a substantially average current value during the measurement and calculate the measurement value in the form of a substantially average current consumption value based on the detected current value and the time measurement. For example, a certain number of measurements per second can be carried out and an average current value for the one second and a power consumption value in the one second can be calculated.

The verification apparatus 10 also includes a numerical value generator in the form of an auxiliary measuring device 20′ to assist the measuring device 20′ in providing the uniqueness of the output. The auxiliary measuring device 20′ detects a power supply (not shown) of the verification apparatus 10, such that an auxiliary measurement value power consumption of the verification apparatus 10 can be generated. Alternatively, the auxiliary measuring device 20′ can be equipped or designed to obtain something else, such as time, time span, temperature, sound, image, etc., or to generate a random number, such that an auxiliary measurement value can be generated.

The verification apparatus 10 includes a counter. The verification apparatus 10 has an identifier and the data processing device 50 is configured to receive the signal from the measuring device 20 and to generate the measurement value, e.g. a power consumption value of an external device connected to the transmission line 2 and to combine the identifier and the measurement value and optionally the auxiliary measurement value according to a predetermined coding algorithm in order to generate an output. The data processing device 50 is further configured to update a counter value of the counter with the measurement value. The verification apparatus 10 comprises an output device 30 which is arranged to output the output, such that the output can be transmitted to the generator device 90 via a user terminal 80. The generator device 90 is configured to analyze or decode the output to obtain the identifier and measurement value and store it in non-volatile generator data storage. The generator device 90 is configured to generate a one-time password using at least part of the identifier or the measurement value and to transmit it to the user terminal 80, such that the one-time password can be transmitted to the verification apparatus 10 via an input device 40 as a response to the output, such that a first transaction by the user is authenticated by the verification apparatus 10. The verification apparatus 10 is configured to verify the one-time password to turn on/off the switch 70 depending on the result of the verification.

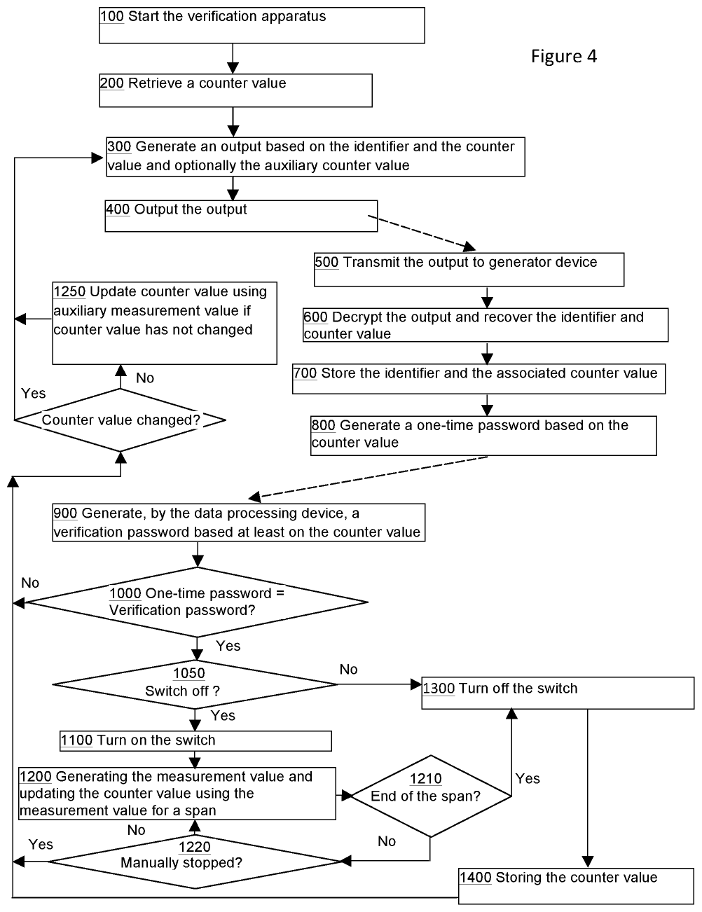

As illustrated representatively in FIG. 1 with arrows and further illustrated in FIG. 4 by a flow chart, a preferred embodiment of a verification method according to the invention comprises starting 100 a verification apparatus 10 with an identifier, such that the data processing device 50 loads and executes a computer program with an output generator module 56 and a verification module 58 from a memory 54 through a processor 52, such that the data processing device 50 retrieves 200 a counter value from the memory 54 after the start of the verification apparatus 10, using at least the counter value and the identifier and optionally the auxiliary counter value, an output is generated by coding or encryption according to a predetermined coding algorithm 300 and outputs 400 it via the output device 30. Note that starting may comprise powering-on or restarting and the output after start includes a first output generated using at least the retrieved counter value. Using the auxiliary measuring device, the data processing device obtains the properties of the power supply of the verification apparatus 10, such as the current intensity or voltage, in order to generate an auxiliary measurement value. The computer program can include a plurality of coding algorithms, it being possible for the predetermined coding algorithm to be selected based at least on the counter value. The output may contain a one-time beacon or a nonce. The output is transmitted 500 by a user through the user terminal 80, e.g. mobile phone, via a web page to a generator device 90, such that the user can obtain a one-time password from the generator device 90 and enter the one-time password into the verification apparatus in response to the output.

As illustrated representatively in FIG. 1 with arrows and further illustrated in FIG. 4 by a flow chart, a preferred embodiment of a one-time password generation method according to the invention comprises execution of a generator computer program by a generator device 90, to obtain the output, analyze or decode it according to a predetermined decoding algorithm, to restore or extract 600 from the output an identifier of the verification apparatus 10 and the associated counter value, to store 700 the identifier and the associated counter value in an associated manner in a generator memory 95, to generate the one-time password using at least the counter value according to a predetermined one-time password algorithm and transmit 800 it to the user terminal 80. A security check can be performed based on consecutive counter values, a difference between the successive counter values being determined and compared with a predetermined limit value. The user enters the one-time password into the verification apparatus 10 via the input device 40 as a response to the output in order to be able to identify himself or to identify himself, such that the verification apparatus 10 can authenticate the user or the transaction. The generator computer program can include a variety of decoding algorithms, wherein the predetermined decoding algorithm can be selected based on the output, such that the predetermined decoding algorithm corresponds to the predetermined encoding algorithm. The generator computer program can include a variety of one-time password algorithms, wherein the predetermined one-time password algorithm can be selected based on the output. The verification process returns to the step of getting 600 the output. In this case, an algorithm is selected from among a plurality of algorithms by selecting the algorithm according to a predetermined sequence. Alternatively, the algorithm can be selected from the sequence according to a specific digit of the respective value or a random number.

The verification method further includes starting a data acquisition process by receiving input from the user comprising the one-time password in response to the output, generating 900 a verification password by the data processing device 50 using at least the counter value according to a predetermined verification algorithm, comparing 1000 the verification password to the one-time password and determining whether the verification password and the one-time password match to verify the one-time password. The computer program can include a plurality of verification algorithms, with the predetermined verification algorithm being able to be selected based on the output or one-time password, such that the predetermined verification algorithm corresponds to the predetermined one-time password algorithm. Once the one-time password does not match the verification password, the verification method returns to the step of generating an output 300, completing the data acquisition process. The counter value can be changed 1250 by adding the auxiliary measurement value obtained using the auxiliary measuring device 20′, such that the output differs from the output last generated once there is no new measurement value and the counter value has remained the same so far or once the counter value already was used when generating a previous output. In doing so, the data processing device updates and stores an auxiliary counter value by adding the auxiliary measurement value and ends the acquisition of the auxiliary measurement value. Alternatively, the auxiliary measurement value can be combined with the measurement value according to the coding algorithm and not added. Note that the output is generated using at least the updated counter value, and the first output after start is generated using at least the counter value retrieved from data storage.

Once the one-time password matches the verification password, the data processing device 50 turns on 1100 the switch 70, such that a transmission occurs in the transmission line 2, at least one transmission characteristic being detected by the measuring device 20 and a transmission characteristic relating to the detected transmission being transmitted to the data processing device 50 as a signal. At this time, the data processing device 50 calculates 1200 a measurement value using the signal and updates the counter value using the measurement value until the switch is turned off 1300. The data processing device 50 monitors a period of time during transmission by the time measuring unit by measuring elapsed time. The data processing device 50 turns off 1210 the switch 70 1300 based on the monitored period or elapsed time or the calculated measurement value reaching a set point. Optionally, the data processing device 50 turns off 1300 the switch 70 based on a user interrupting the transmission 1220. The verification method returns to the step of generating 300 an output to generate a next output, completing the data acquisition process. Updating the counter value may also occur after the power down step and before the return step. In this case, the method between the step of generating 300 an output and comparing 1000 is repeated.

With the switch 1050 on, once the one-time password matches the verification password 1000, the data processing device 50 turns off 1300 the switch 70, such that the transmission in the transmission line 2 is interrupted. The data processing device 50 stores 1400 the updated counter value or the calculated measurement value and, if applicable, the monitored time period in the memory 54. The verification method returns to the step of generating 300 an output to generate a next output, whereby the data acquisition process is terminated. Note that the next output will be generated using at least the updated counter value, wherein the first output after the start is generated using at least the counter value retrieved from the memory. In this case, the method between the step of generating 300 an output and comparing 1000 is repeated. Once the counter value has not been changed, i.e. once the measuring device does not provide a measurement value, since there is no transmission or once the counter value has already been used in generating a previous e.g. first output, the counter value is updated using the auxiliary measurement value, wherein the counter value is changed 1250 by adding the auxiliary measurement value obtained using the auxiliary measuring device 20′. In doing so, the data processing device updates and stores an auxiliary counter value by adding the auxiliary measurement value and ends the acquisition of the auxiliary measurement value.

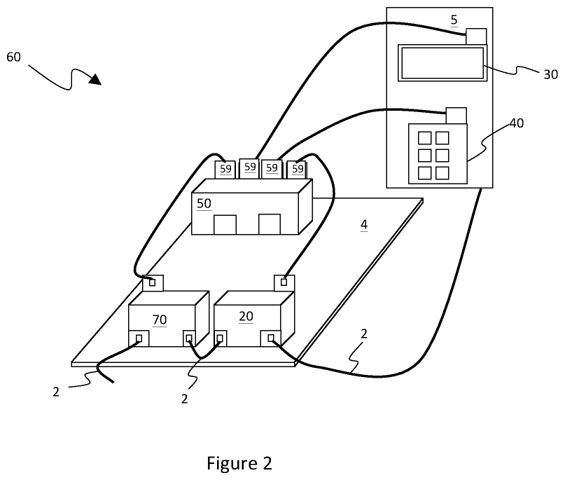

FIG. 2 shows a preferred embodiment of an actuator arrangement 60 according to the invention, comprising a switch frame 4 and a user interface carrier 5, wherein a data processing device 50 and a switch 70 with a relay are arranged on the switch frame 4 and an output device 30 with a display and an input device with a keypad are arranged on the user interface substrate 5. The switch frame 4 and the user interface support 5 are arranged such that they can move with respect to one another. The electrical switch 70 and a measuring device 20 with a current sensor are arranged on a load current line 2, which extends from a power source connection, e.g. plug (not shown) to a load connection arranged on the user interface carrier 5, e.g. a socket or a wireless charging arrangement (not shown), which may alternatively be located elsewhere. The measuring device 20, the current sensor, the switch 70, the relay, the output device 30, the display, the input device and the keypad are connected to the data processing device 30 via signal lines and corresponding signal connections 59 or power lines (not shown) and are controlled by the data processing device 30 controlled and supplied.

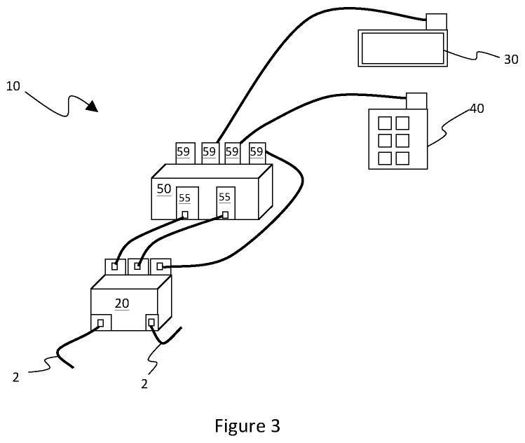

FIG. 3 schematically represents the verification apparatus 10 shown in FIG. 2, the measuring device 20 with the current sensor being supplied by a control circuit via control current connections 55. In this case, the measuring device 20 can be equipped with another transducer for detecting the properties of the transmission line 2 instead of a current sensor.

The above description is not limiting. Many other examples or adaptations of the above embodiments will be apparent to those skilled in the art upon review of the above description without departing from the scope of the invention. Each of the following claims are incorporated herein as a separate preferred embodiment. Certain features of the disclosed embodiments are shown at an exaggerated scale or schematically, and some details of conventional elements are omitted for clarity and brevity.

The word “a” in this specification appropriately means “one or more” or “at least one”. The term “based on a value” can mean “using at least a part of the value or a derivation of the value”. The word “first” can mean “initial”, “current” or “provisional” and vice versa. The word “subsequent” can mean “next” or “following” and vice versa. The word “previous” can mean “prior” and vice versa. The term “generating” may include “computing” by processing or executing corresponding instructions. The term “obtaining” may include “sensing” by measuring, sensing, querying, or manually inputting.

The preferred embodiments of the invention have been described in the drawings and the description of the preferred embodiments. While these disclosures directly describe the above embodiments, it is understood that those skilled in the art may consider modifications and/or variations to the specific embodiments shown and described herein. Any such modifications or variations that come within the scope of this disclosure are intended to be included therein. Unless expressly stated, it is the inventor's intention to give words and phrases in the specification and claims their usual and customary meaning to those of ordinary skill in the relevant art.

The foregoing description of the preferred embodiments and best modes of the invention known to applicant at the time of application is presented and presented for purposes of illustration. Many modifications and variations are possible in light of the above teachings. Embodiments were chosen and described in order to best illustrate the principles and practice of the invention and to enable those skilled in the art to best utilize the invention in various embodiments and with various modifications as are suited to the particular use contemplated.

The verification apparatus does not have to include an identifier and the output does not have to be generated using the identifier if, for example, the measurement of the verification apparatus is not to be assigned or obtained centrally. Instead of an electrical load current line, the actuator arrangement can be connected to a fluid flow line for control purposes. In such a preferred embodiment, an electrically actuated fluid switch valve is used instead of an electrical switch and a flow sensor is used instead of a current sensor. An algorithm according to the invention includes methods for the step-by-step transformation of character rows, including calculation processes according to a specific, possibly repetitive scheme.

### LIST OF REFERENCES

2 transmission line
4 switch frame
5 user interface support
10 verification apparatus
20 measuring device
20′ auxiliary measuring device
30 output device
40 input device
50 data processing device
52 processor
54 data storage
55 control power connectors
56 output generator module
58 verification module
59 signal line connectors
60 actuator assembly
70 switch
80 user terminal
90 generator device
95 generator data storage

1. A verification apparatus for verifying one-time passwords, comprising a data processing device and a data acquisition device operatively coupled to the data processing device, wherein the data processing device is configured to:
obtain first verification data;
obtain a first one-time password;
perform verification of the first one-time password based at least on the first verification data;
wherein the data processing device is further configured to start a first data acquisition process using the data acquisition device once it obtains the first one-time password and to complete the first data acquisition process before obtaining a subsequent one-time password, wherein the data processing device is configured to obtain subsequent verification data using the data acquisition device during the first data acquisition process.

2. The verification apparatus of claim 1, further comprising an output device operatively coupled to the data processing device, wherein the data processing device is further configured to perform the following:
outputting a first output based at least on the first verification data using the output device;
requesting the first one-time password via the output device preferably by outputting the first output;
obtaining the subsequent verification data for verifying the subsequent one-time password using the data acquisition device once the data processing device receives the first one-time password in response to the request via the data acquisition device;
outputting a subsequent output based at least on the subsequent verification data using the output device;
requesting the subsequent one-time password via the subsequent output device preferably by outputting the output.

3. The verification apparatus of claim 1, wherein the data processing device is configured to obtain the first verification data before requesting the first one-time password, and obtain the subsequent verification data prior to requesting the subsequent one-time password or after requesting the first one-time password; and to complete the first data acquisition process prior to requesting the subsequent one-time password.

4. The verification apparatus of claim 1, wherein the data processing device is configured to generate the subsequent verification data once the data processing device receives the first one-time password or after performing the verification of the first one-time password and regardless of an outcome of the verification, once the data processing device receives the first one-time password via the data acquisition device in response to the request.

5. The verification apparatus according to claim 1, wherein the data acquisition device comprises an input device, such that the data processing device can receive one-time passwords using the input device, wherein the data processing device is configured to extract the subsequent verification data from the one-time passwords.

6. The verification apparatus of claim 1, wherein the data acquisition device comprises a measuring device, the data processing device being configured to obtain the subsequent verification data using the measuring device.

7. The verification apparatus of claim 6, wherein the data processing device is configured to:
carry out a measurement using the measuring device in order to obtain measurement data;
generate an output based at least on the obtained measurement data and to output the output via the output device;
obtain a one-time password in response to the output; and
carry out verification of the one-time password based at least on the measurement data;
wherein the measuring device comprises a connection for connection to a transmission line, via which measurement data relating to a transmission can be obtained.

8. The verification apparatus of claim 6, wherein the measuring device comprises a transducer, wherein the measuring device provides a signal using the transducer, and the data processing device is further configured to receive the signal from the measuring device and to generate the measurement data based at least on the signal.

9. The verification apparatus of claim 6, wherein the verification apparatus further comprises a counter and the data processing device is further configured to update a counter value of the counter using the measurement data, wherein the output is generated based at least on the counter value such that the counter value can be output via the output device.

10. The verification apparatus of claim 1, further comprising a numerical value generator for generating an auxiliary numerical value, wherein the data processing device is further configured to generate an auxiliary numerical value using the numerical value generator, wherein the output is generated further based on the auxiliary numerical value if the data acquisition device is not able to obtain subsequent verification data.

11. The verification apparatus of claim 1, further comprising a memory storing at least first verification data, wherein the data processing device is configured to obtain first verification data from the memory when started.

12. A verification apparatus for verification of one-time passwords, wherein the verification apparatus comprises an output device, an input device, a measuring device, and a data processing device operatively coupled to the output device, the input device, and the measuring device and configured to:
carry out a measurement using the measuring device in order to obtain measurement data;
generate an output based at least on the measurement data and output the output via the output device;
obtain a one-time password in response to the output via the input device; and
carry out verification of the one-time password based at least on the measurement data to verify the one-time password.

13. The verification apparatus according to claim 12, wherein the verification apparatus further comprises a switch operatively coupled with the data processing device, wherein the data processing device is configured to turn on or off the switch if the one-time password is verified.

14. The verification apparatus according to claim 12, wherein the data processing device is configured to:
obtain first verification data;
obtain measurement data as subsequent verification data using the measuring device as a data acquisition device once the data processing device receives a first one-time password;
obtain the one-time password as a subsequent one-time password;
perform verification of the first one-time password based at least on the first verification data;
start a first data acquisition process once the data processing device obtains the first one-time password and end the first data acquisition process before the data processing device obtains the subsequent one-time password, wherein the data processing device is configured to obtain the subsequent verification data during the first data acquisition process.

15. The verification apparatus according to claim 12, wherein the measuring device is arranged to detect a transmission in a transmission line when the switch is switched on, such that the data processing device generates measurement data relating to the transmission;
wherein the verification apparatus is designed for controlling the transmission line, wherein the switch is arranged on the transmission line and the data processing device is configured to turn on or off the switch to connect or disconnect the transmission line.

16. A verification method for verifying one-time passwords by a verification apparatus comprising a data processing device and a data acquisition device operatively coupled to the data processing device, wherein the verification method comprises:
obtaining first verification data;
obtaining a first one-time password;
performing verification of the first one-time password based at least on the first verification data;
starting a first data acquisition process once the data processing device obtains the first one-time password;
obtaining subsequent verification data using the data acquisition device during the first data acquisition process;
completing the first data acquisition process before the data processing device obtains a subsequent one-time password.

17. The verification method according to claim 16, wherein the verification apparatus further comprises an output device, an input device and a counter that provides a counter value, wherein the data acquisition device comprises a measuring device, wherein the verification method further comprises:
obtaining first verification data comprises retrieving the counter value as first verification data;
generating an output based at least on the counter value;
outputting the output via the output device;
obtaining a one-time password as first one-time password via the input device in response to the output;
generating a verification password based at least on the counter value;
performing verification of the one-time password based on the verification password.

18. The verification method according to claim 16, wherein the verification apparatus further comprises a switch, wherein the verification method further comprises:
turning on the switch if the one-time password has been verified;
performing a measurement using the measuring device and updating the counter value using a measurement value generated by the measuring device as subsequent verification data during measurement until the switch is turned off.

19. The verification method according to claim 16, further comprising:
storing the counter value;
updating the counter value using an auxiliary measurement value, if counter value has not changed.

20. The verification method according to claim 16, further comprising transferring and inputting the output to a generator device, decrypting the output and recovering at least the identifier and the counter value by the generator device, generating the one-time password based at least on the counter value generator device and transferring the generated one-time password to the verification apparatus as the first one-time password.
